(19) United States
(12) Patent Application Publication
(10) Pub. No.: US 2024/0177290 A1
(43) Pub. Date: May 30, 2024

(54) PROCESSING APPARATUS, PROCESSING METHOD, AND NON-TRANSITORY STORAGE MEDIUM

(71) Applicant: NEC Corporation, Tokyo (JP)

(72) Inventor: Sachio IWASAKI, Tokyo (JP)

(73) Assignee: NEC Corporation, Tokyo (JP)

(21) Appl. No.: 18/514,233

(22) Filed: Nov. 20, 2023

(30) Foreign Application Priority Data
Nov. 28, 2022 (JP) 2022-189040

(51) Int. Cl. G06T 7/00; G06V 40/10; G08B 21/18

(52) U.S. Cl. CPC G06T 7/0004; G06V 40/103; G06V 40/107; G08B 21/182; G06T 2207/30164

(57) ABSTRACT

In order to detect an abnormal work with high accuracy by image analysis, the present invention provides a processing apparatus 10 including a first computation unit 11 that computes a first degree of abnormality being a degree of abnormality of a work at each image photographing time, based on a processing result of each of a plurality of images acquired by photographing a state of a first work being performed for a predetermined time; and a second computation unit 12 that computes a second degree of abnormality being a degree of abnormality of the first work, based on a plurality of the first degrees of abnormality computed in association with each of the plurality of images.

This application is based upon and claims the benefit of priority from Japanese patent application No. 2022-189040, filed on Nov. 28, 2022, the disclosure of which is incorporated herein in its entirety by reference.

### TECHNICAL FIELD

The present invention relates to a processing apparatus, a processing method, and a program.

### BACKGROUND ART

A technique associated with the present invention is disclosed in International Patent Publication No. WO2016/079833. In the technique, a feature value is computed for each frame in a first moving image acquired by photographing a normal work movement, and a feature value is computed for each frame in a second moving image acquired by photographing a work movement of a target to be observed. Subsequently, in the technique, several frames associated with a frame to be processed in the second moving image are determined in the first moving image. Further, in the technique, an abnormal value is computed for each pair by collating a feature value of a frame to be processed with a feature value of each of the associated several frames. Then, in the technique, a lowest abnormal value is set as an abnormal value of the frame to be processed, and a determination result is output when the abnormal value of the frame to be processed exceeds a threshold value.

### DISCLOSURE OF THE INVENTION

A technique of detecting an abnormal work by image analysis has been desired. The abnormal work is, for example, a work being performed by a method different from a determined method (such as a tool, a content, or a place), and the like.

In the technique disclosed in International Patent Publication No. WO2016/079833, an abnormal value at a certain timing (a timing at which a frame to be processed is photographed) is computed, and an abnormality is detected by comparison of the abnormal value with a threshold value. In this way, in a case of a technique of detecting an abnormal work, based on a degree of abnormality (image analysis result) at each timing, erroneous detection frequently occurs.

For example, as illustrated in FIG. 14, a result of image analysis may indicate a large degree of abnormality momentarily due to an unexpected factor not being related to a work content, such as a failure of a computer, a noise, or image distortion due to a momentary change in a photographing environment. In a case of a technique of detecting an abnormal work, based on a degree of abnormality (image analysis result) at each timing, occurrence of an abnormal work is erroneously detected based on a momentarily large degree of abnormality not being related to a work content as described above.

In view of the above-described problem, one example of an object of the present invention is to provide a processing apparatus, a processing method, and a program that achieve a task in which an abnormal work is detected with high accuracy by image analysis.

In one aspect of the present invention, provided is a processing apparatus including:
a first computation unit that computes a first degree of abnormality being a degree of abnormality of a work at each image photographing time, based on a processing result of each of a plurality of images acquired by photographing a state of a first work being performed for a predetermined time: and
a second computation unit that computes a second degree of abnormality being a degree of abnormality of the first work, based on a plurality of the first degrees of abnormality computed in association with each of the plurality of images.

In one aspect of the present invention, provided is a processing method including,
by one or more computers:
computing a first degree of abnormality being a degree of abnormality of a work at each image photographing time, based on a processing result of each of a plurality of images acquired by photographing a state of a first work being performed for a predetermined time: and
computing a second degree of abnormality being a degree of abnormality of the first work, based on a plurality of the first degrees of abnormality computed in association with each of the plurality of images.

In one aspect of the present invention, provided is a program causing a computer to function as:
a first computation unit that computes a first degree of abnormality being a degree of abnormality of a work at each image photographing time, based on a processing result of each of a plurality of images acquired by photographing a state of a first work being performed for a predetermined time; and
a second computation unit that computes a second degree of abnormality being a degree of abnormality of the first work, based on a plurality of the first degrees of abnormality computed in association with each of the plurality of images.

According to one aspect of the present invention, a processing apparatus, a processing method, and a program that achieve a task in which an abnormal work is detected with high accuracy by image analysis are achieved.

### BRIEF DESCRIPTION OF THE DRAWINGS

The above-described object, other objects, features, and advantages will become more apparent from suitable example embodiments described below and the following accompanying drawings:

FIG. 1 is a diagram illustrating one example of a functional block diagram of a processing apparatus;

FIG. 2 is a diagram illustrating an overview of one example of processing to be performed by the processing apparatus;

FIG. 3 is a diagram illustrating one example of a hardware configuration of the processing apparatus;

FIG. 4 is a diagram illustrating another example of a functional block diagram of the processing apparatus;

FIG. 5 is a diagram illustrating one example of processing of computing a second degree of abnormality to be performed by the processing apparatus;

FIG. 6 is another diagram illustrating one example of processing of computing a second degree of abnormality to be performed by the processing apparatus;

FIG. 7 is another diagram illustrating one example of processing of computing a second degree of abnormality to be performed by the processing apparatus;

FIG. 8 is a flowchart illustrating one example of a flow of processing of the processing apparatus;

FIG. 9 is a diagram illustrating an overview of another example of processing to be performed by the processing apparatus;

FIG. 10 is a diagram illustrating another example of a functional block diagram of the processing apparatus;

FIG. 11 is a diagram illustrating another example of a functional block diagram of the processing apparatus;

FIG. 12 is a diagram schematically illustrating one example of information to be output from the processing apparatus;

FIG. 13 is a flowchart illustrating another example of a flow of processing of the processing apparatus; and

FIG. 14 is a diagram illustrating a task.

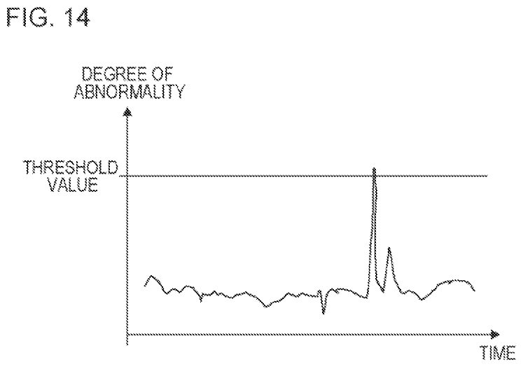

### DESCRIPTION OF EMBODIMENTS

Hereinafter, example embodiments according to the present invention are described by using the drawings. Note that, in all drawings, a similar constituent element is indicated by a similar reference sign, and description thereof is omitted as necessary.

### First Example Embodiment

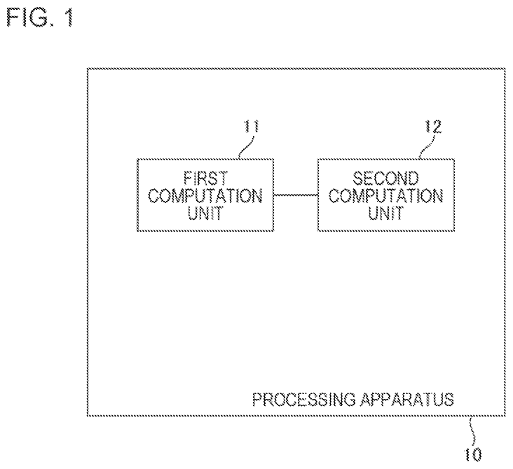

FIG. 1 is a functional block diagram illustrating an overview of a processing apparatus according to a first example embodiment. The processing apparatus 10 includes a first computation unit 11, and a second computation unit 12.

The first computation unit 11 computes a first degree of abnormality being a degree of abnormality of a work at each image photographing time, based on a processing result of each of a plurality of images acquired by photographing a state of a first work being performed for a predetermined time. The second computation unit 12 computes a second degree of abnormality being a degree of abnormality of the first work, based on a plurality of the first degrees of abnormality computed in association with each of the plurality of images.

In this way, after computing a degree of abnormality (first degree of abnormality) at each timing (at each image photographing time) while a first work is being performed, the processing apparatus 10 computes a degree of abnormality (second degree of abnormality) of the first work by integrating a result of the computation. The first degree of abnormality may become a large value momentarily due to an unexpected factor not being related to a work content, for example, a failure of a computer, a noise, image distortion due to a momentary change in a photographing environment, or the like. However, according to the processing apparatus 10, even when the first degree of abnormality becomes a large value momentarily, the momentary influence by the first degree of abnormality is weakened or ignored when the second degree of abnormality is computed. Consequently, even when the first degree of abnormality becomes a large value momentarily due to an unexpected factor not being related to a work content, it is possible to suppress an inconvenience that occurrence of an abnormal work is erroneously detected based on the result.

In this way, in the processing apparatus 10 according to the present example embodiment, it becomes possible to detect an abnormal work with high accuracy by image analysis.

### Second Example Embodiment

### “Overview”

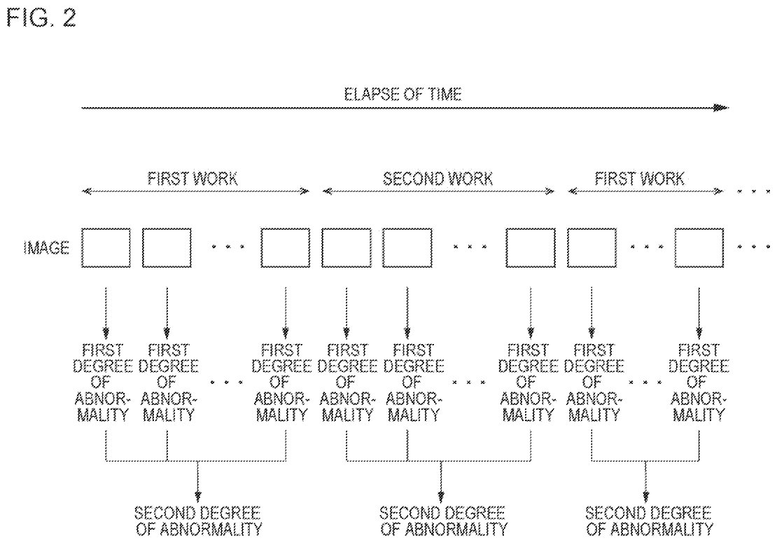

A processing apparatus 10 according to a present example embodiment is an embodiment of the processing apparatus 10 according to the first example embodiment. An overview of processing to be performed by the processing apparatus 10 is described below by using FIG. 2.

First, in the present example embodiment, a moving image in which a state that a worker is performing a work is photographed is input to the processing apparatus 10.

A worker performs a plurality of works in a predetermined order. For example, as illustrated in FIG. 2, a worker alternately performs a first work and a second work. Although not illustrated, a worker may repeatedly perform three or more works in a predetermined order.

The processing apparatus 10 analyzes an input moving image, and determines a work being performed at a photographing timing of each frame image. Consequently, as illustrated in FIG. 2, a time zone when each work is being performed, a switching timing of a work, and the like are determined.

Subsequently, as illustrated in FIG. 2, the processing apparatus 10 computes a first degree of abnormality being a degree of abnormality of a work at each image photographing time for each image by processing each of a plurality of images (frame images) acquired by photographing a state of each work being performed for a predetermined time. Then, the processing apparatus 10 computes a second degree of abnormality being a degree of abnormality of each work for each work, based on a plurality of the first degrees of abnormality computed in association with each of the plurality of images. As illustrated in FIG. 2, when each work is repeatedly performed a plurality of times, the processing apparatus 10 computes the second degree of abnormality for each work at each time.

Then, the processing apparatus 10 detects an abnormal work, based on the second degree of abnormality computed for each work. Hereinafter, a configuration of the processing apparatus 10 as above is described in detail.

### “Hardware Configuration”

One example of a hardware configuration of the processing apparatus 10 is described below. Each functional unit of the processing apparatus 10 is achieved by any combination of hardware and software. A person skilled in the art may naturally understand that there are various modification examples as a method of achieving the configuration. The software includes a program stored in advance at a stage of shipping an apparatus, a storage medium such as a compact disc (CD), a program downloaded from a server or the like on the Internet, and the like.

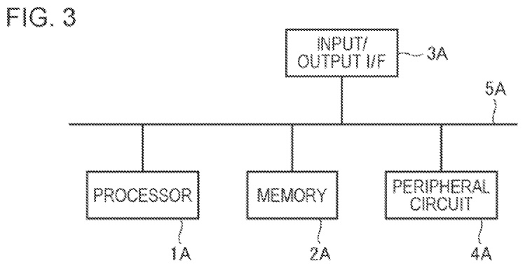

FIG. 3 is a block diagram illustrating a hardware configuration of the processing apparatus 10. As illustrated in FIG. 3, the processing apparatus 10 includes a processor 1A, a memory 2A, an input/output interface 3A, a peripheral circuit 4A, and a bus 5A. The peripheral circuit 4A includes various modules. The processing apparatus 10 may not include the peripheral circuit 4A. Note that, the processing apparatus 10 may be constituted of a plurality of apparatuses that are physically and/or logically separated. In this case, each of the plurality of apparatuses can include the above-described hardware configuration.

The bus 5A is a data transmission path along which the processor 1A, the memory 2A, the peripheral circuit 4A, and the input/output interface 3A mutually transmit and receive data. The processor IA is an arithmetic processing apparatus, for example, such as a CPU and a graphics processing unit (GPU). The memory 2A is a memory, for example, such as a random access memory (RAM) and a read only memory (ROM). The input/output interface 3A includes an interface for acquiring information from an input apparatus, an external apparatus, an external server, an external sensor, a camera, and the like, an interface for outputting information to an output apparatus, an external apparatus, an external server, and the like, and the like. Further, the input/output interface 3A may include an interface for connecting to a communication network such as the Internet. The input apparatus is, for example, a keyboard, a mouse, a microphone, a physical button, a touch panel, and the like. The output apparatus is, for example, a display, a speaker, a printer, a mailer, and the like. The processor 1A can issue a command to each module, and perform an arithmetic operation, based on these arithmetic operation results.

### “Functional Configuration”

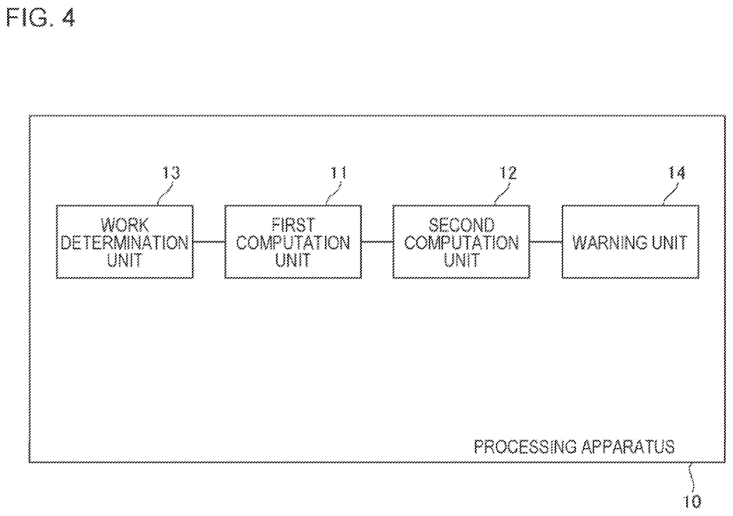

A functional configuration of the processing apparatus 10 according to the present example embodiment is described below in detail. FIG. 4 illustrates one example of a functional block diagram of the processing apparatus 10. As illustrated in FIG. 4, the processing apparatus 10 includes a first computation unit 11, a second computation unit 12, a work determination unit 13, and a warning unit 14.

The work determination unit 13 analyzes an image, and determines a work being performed when each image is photographed.

An “image” is acquired from a moving image input to the processing apparatus 10. As described above, in the present example embodiment, a moving image in which a state that a worker is performing a work is photographed is input to the processing apparats 10. All frame images included in an input moving image may become an image to be processed by the work determination unit 13. Further, some of frame images included in an input moving image, for example, frame images intermittently extracted in accordance with a predetermined rule may become an image to be processed by the work determination unit 13.

In the present example embodiment, a moving image generated by a camera is input to the processing apparatus 10 in real time. A configuration in which a moving image generated by a camera is input to the processing apparatus 10 in real time is achieved by utilizing any known technique. For example, the processing apparatus 10 and a camera may be communicably connected to each other. Note that, as a modification example, a moving image generated by a camera may be input to the processing apparatus 10 by any means by batch processing.

The camera photographs a work space of a worker. The camera is configured in such a way as to photograph any photographing target capable of determining a work being performed by a worker. As the photographing target, a worker, a hand of a worker, a work object (such as a product and a material), a tool, a workbench, and the like are exemplified, but the photographing target is not limited thereto.

The camera may be a fixed point camera fixed at a predetermined position. In addition, the camera may be a wearable camera worn by a worker. In addition, the camera may be a camera included in a robot having an autonomous moving mechanism. The camera continuously photographs a moving image.

A content of a “work” is not specifically limited. For example, the processing apparatus 10 can be utilized at any scene such as a factory, a warehouse, a restaurant, a fast food restaurant, a supermarket, a convenience store, an amusement facility, a public facility, and a company. The content of a work becomes a content according to a usage scene of the processing apparatus 10.

For example, as a work in a factory, “attaching a part A”, “soldering”, “removal of a seat”, and the like are exemplified. Or, as a work in a hamburger shop, “preparation of buns”, “placing lettuce on buns”, “placing putty on lettuce”, “placing cheese on putty”, “placing tomatoes on cheese”, and “pouring sauce on tomatoes”, and the like are exemplified. Each work is performed for a time from several seconds to about several minutes.

One example of processing of determining a work being performed when each image is photographed by image analysis is described below. A feature of an external appearance of a work object, a feature of a workbench, a feature of surroundings of a work object, a feature of a position of a work object, a feature of a hand of a worker, a feature of a tool to be utilized, and the like when each of a plurality of works is being performed are registered in advance. The work determination unit 13 can determine a work being performed when each image is photographed by searching for an image and detecting these features.

For example, the work determination unit 13 can compute a degree of confidence with which each of a plurality of works is being performed when each image is photographed. Specifically, the work determination unit 13 can compute, as an analysis result of a certain image, a degree of confidence with which each work is being performed when the image is photographed, such as a first work (95%), a second work (30%), and a third work (47%). Then, the work determination unit 13 can determine a work in which a degree of confidence is highest, as a work being performed when the image is photographed.

There are various methods of computing a degree of confidence, and any known technique can be adopted. For example, in a case where a plurality of features unique to each work are registered, a degree of confidence may be increased, as more features are detected. Further, a degree of confidence may be increased as each feature is detected with higher reliability.

By the processing by the work determination unit 13, as illustrated in FIG. 2, a time zone when each work is being performed, a switching timing of a work, and the like are determined.

The first computation unit 11 computes a first degree of abnormality being a degree of abnormality of a work at each image photographing time, based on a processing result of each of a plurality of images acquired by photographing a state of each work (such as a first work and a second work) being performed for a predetermined time.

As one example, the first computation unit 11 may compute a first degree of abnormality by using the above-described degree of confidence. Specifically, when a work at a time of photographing a certain image is determined as a first work, the first computation unit 11 can compute a first degree of abnormality, based on a degree of confidence of the first work. In this case, the first computation unit 11 computes a higher first degree of abnormality as a degree of confidence is lower. For example, when it is assumed that a degree of confidence is D, the first computation unit 11 may compute, as a first degree of abnormality, “(constant)/D”, “(constant)-D”, “-logD”, “a sum or a product of these values”, and the like. The constant is, for example, 1, but is not limited thereto.

Note that, a method of computing a first degree of abnormality is not limited to this example. The first computation unit 11 may compute a first degree of abnormality being a degree of abnormality of a work at each image photographing time by using another method.

The second computation unit 12 computes a second degree of abnormality being a degree of abnormality of each work, based on a plurality of first degrees of abnormality computed in association with each of a plurality of images. As illustrated in FIG. 2, the second computation unit 12 computes a second degree of abnormality for each work, based on a plurality of first degrees of abnormality computed from each of a plurality of images acquired by photographing a state of each work.

The second computation unit 12 can compute a second degree of abnormality by statistically processing a plurality of first degrees of abnormality. There are various methods of statistical processing, and “computing various statistical values (such as an average value, a maximum value, a minimum value, a mode, and a median)”, “computing various statistical values after removing a deviated value in accordance with a predetermined rule”, and the like are exemplified. In addition, the second computation unit 12 may compute a second degree of abnormality by performing either of statistical processing examples 1 and 2 described below.

### “Statistical Processing Example 1”

In the example, the second computation unit 12 computes a second degree of abnormality, based on the following equation (1). f(x) is the second degree of abnormality.

$$\begin{matrix}[ Mathematical 1 ] & \\ f ( x ) = \frac{1}{N} {( {\sum }_{i = 1}^{N} {x}_{i}^{p} )}^{1 / p} & equation ( 1 )\end{matrix}$$

x is a first degree of abnormality.
i is a serial number for identifying each of a plurality of first degrees of abnormality computed from each of a plurality of images acquired by photographing a state of each work.
N is the number of a plurality of first degrees of abnormality computed from each of a plurality of images acquired by photographing a state of each work.
p is an adjustment value capable of being optionally set by the user. p is a value larger than 0.

When p=1, an average value of first degrees of abnormality is computed as a second degree of abnormality.

When p>1, a value acquired by multiplying, to the power of 1/p, a total of a value acquired by multiplying each first degree of abnormality to the power of p, and dividing the value by N is computed as a second degree of abnormality. By doing so, when the first degree of abnormality becomes large only for a short time, an influence of the first degree of abnormality on the second degree of abnormality can be ignored. Then, when the first degree of abnormality becomes large for a relatively long time, an influence of the first degree of abnormality appears on the second degree of abnormality.

### “Statistical Processing Example 2”

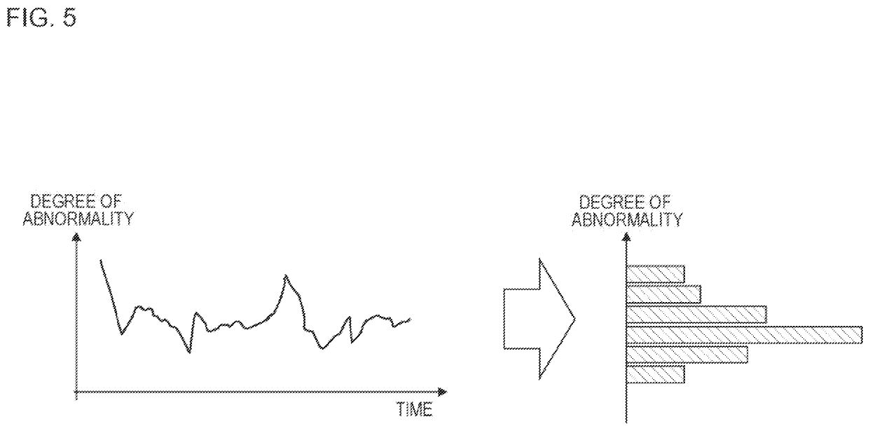

In the example, as illustrated in FIG. 5, the second computation unit 12 generates a histogram of a degree of abnormality from a plurality of first degrees of abnormality computed from each of a plurality of images acquired by photographing a state of each work.

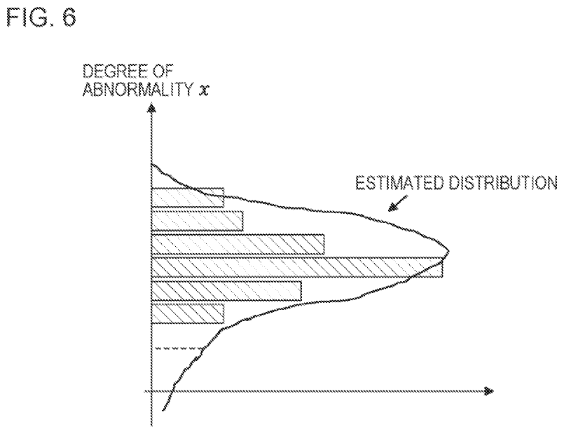

Subsequently, as illustrated in FIG. 6, the second computation unit 12 derives an approximate curve of the histogram. The approximate curve can be derived by any method. For example, the second computation unit 12 may estimate μ and σ, based on a Gaussian distribution formula expressed by the following equation (2). μ is an average, and σ² is a variance. In addition, the second computation unit 12 may estimate a and b, based on a beta distribution formula expressed by the following equation (3). a and b are parameters that determine an average and a variance. For estimation, for example, utilizing a least squares method may be conceived, but the method is not limited thereto. Since Gaussian distribution and beta distribution are widely known, description thereof is omitted herein.

$$\begin{matrix}[ Mathematical 2 ] & \\ Gauss ( x ) = \frac{1}{\sqrt{2 {πσ}^{2}}} exp [ - \frac{{( x - μ )}^{2}}{2 {σ}^{2}} ] & equation ( 2 )\end{matrix}$$

$$\begin{matrix}[ Mathematical 3 ] & \\ Beta ( x ) = \frac{( a + b - 1 ) !}{a ! b !} {{x}^{a - 1} ( 1 - x )}^{b - 1} & equation ( 3 )\end{matrix}$$

Equations (2) and (3) are functions that return a real number from the first degree of abnormality x. A value (value returned from a function) when x=c in the distribution is regarded as a probability that a true first degree of abnormality is c.

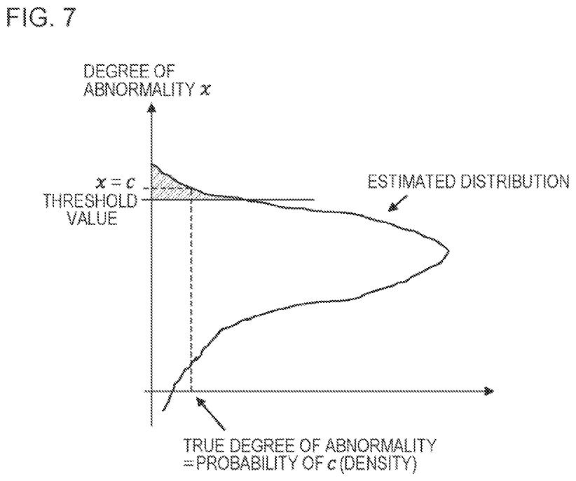

Then, as illustrated in FIG. 7, the second computation unit 12 derives, as a second degree of abnormality, an area (probability that a degree of abnormality is equal to or more than a threshold value) of a portion where the degree of abnormality is equal to or more than a threshold value in the distribution. Computation on the area can be achieved by using any known technique.

When the second degree of abnormality exceeds a warning value, the warning unit 14 performs warning processing. The warning value is a value that is defined in advance. The warning value is a value serving as a trigger for performing warning processing.

The warning processing is, for example, an output of warning information via an output apparatus. As the output apparatus, a display, a projection apparatus, a speaker, a warning lamp, a vibration, and the like are exemplified, but the output apparatus is not limited thereto. The output apparatus may be installed near a worker, or may be installed near a supervisor who supervises a worker.

Further, the warning processing may include processing of notifying a notification partner registered in advance that a second degree of abnormality has exceeded a warning value by using any means such as an electronic mail or push notification of an application.

The following examples are conceived as an execution timing of warning processing.

As described above, as illustrated in FIG. 2, by processing by the work determination unit 13, a time zone when each work is being performed, a switching timing of a work, and the like are determined. In a case where the work determination unit 13 analyzes an image in real time, these parameters are determined in real time. For example, the second computation unit 12 may compute a second degree of abnormality in response to finishing of each work (in response to switching to another work) and perform warning processing by the warning unit 14 in response to computation of the second degree of abnormality. This enables to perform detection (detection of an abnormal work) and warning that a second degree of abnormality has exceeded a warning value in real time.

In addition, computation of a second degree of abnormality by the second computation unit 12, and warning processing by the warning unit 14 may be performed by batch processing. For example, images for half a day, one day, one week, one month, and the like are input to the processing apparatus 10 collectively, and the work determination unit 13 may analyze these images by batch processing. Then, the second computation unit 12 may compute a second degree of abnormality by processing an analysis result of images for half a day, one day, one week, one month, and the like in a batch manner, and warning processing by the warning unit 14 may be performed in response to computation of the second degree of abnormality. In this case, the warning unit 14 may generate and output warning information that identifies a date, time, and a work (such as a first work and a second work) when a second degree of abnormality has exceeded a warning value, information that identifies a worker, information that identifies a working place, and information indicating the number of times that a second degree of abnormality has exceeded, and the like. A worker and a working place at each image photographing time may be determined by image analysis, or may be determined by another method.

Note that, as warning processing by the warning unit 14, the following modification examples may be adopted. First, a plurality of warning values are defined. The plurality of warning values are values different from each other. Then, the warning unit 14 determines whether the second degree of abnormality has exceeded one of the plurality of warning values, and performs warning processing by a method associated with a determined result. The plurality of warning values are values that are defined in advance. Each of the plurality of warning values are values serving as a trigger for performing warning processing by each method.

Specifically, a method of warning processing when a second degree of abnormality has exceeded only a first waning value, and a method of warning processing when a second degree of abnormality has exceeded a first warning value and a second warning value are defined in advance. Then, the warning unit 14 performs warning processing by the method associated with a determined result. Note that, herein, an example in which a first warning value and a second warning value are defined has been described, but three or more warning values may be defined.

As a variation of a method of warning processing, for example, “notification to a worker”, “notification to a worker and a supervisor”, and the like are conceived. In this case, “notification to a worker” may be adopted when a second degree of abnormality has exceeded a first warning value, and “notification to a worker and a supervisor” may be adopted when a second degree of abnormality has exceeded a first warning value and a second warning value.

In addition, as a variation of a method of warning processing, for example, “display of warning information on a display”, “display of warning information on a display, and output of a warning sound via a speaker”, and the like are conceived. As one example in this case, “display of warning information on a display” is adopted when a second degree of abnormality has exceeded only a first warning value. Further, when a second degree of abnormality has exceeded a first warning value and a second warning value, “display of warning information on a display, and output of a warning sound via a speaker” is adopted. In another example, when a second degree of abnormality has exceeded a first warning value, “output of a warning sound via a speaker” is adopted. Further, when a second degree of abnormality has exceeded a first warning value and a second warning value, “display of warning information on a display, and output of a warning sound via a speaker” is adopted.

In addition, as a variation of a method of warning processing, for example, a variation of a way of displaying warning information on a display is conceived. For example, a color, a size, and the like of warning information to be displayed may be differentiated between when a second degree of abnormality has exceeded only a first warning value, and when a second degree of abnormality has exceeded a first warning value and a second warning value. Further, in this case, warning information may be displayed in a blinking manner for the purpose of making warning information more conspicuous when a second degree of abnormality has exceeded a first warning value and a second warning value.

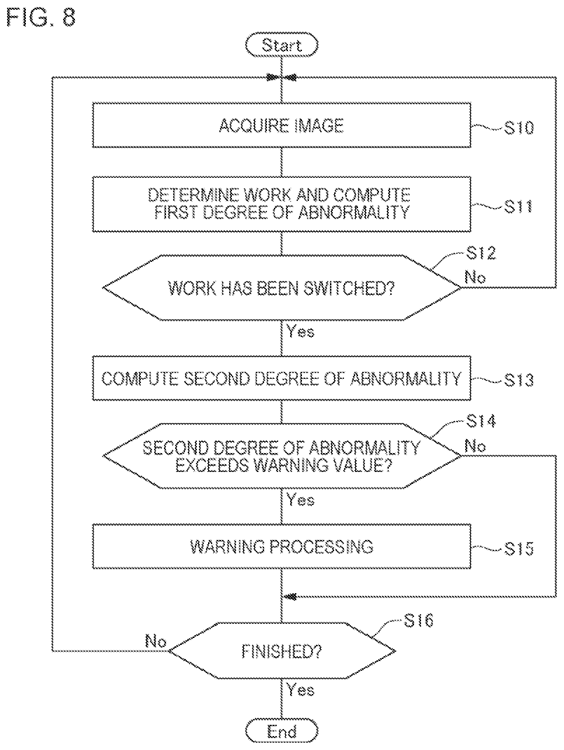

Next, one example of a flow of processing of the processing apparatus 10 is described by using a flowchart in FIG. 8.

The processing apparatus 10 acquires one image (S10). Subsequently, the processing apparatus 10 analyzes the image, and determines a work being performed when the image is photographed (S11). Further, the processing apparatus 10 analyzes the image, and computes a first degree of abnormality being a degree of abnormality of a work when the image is photographed (S11). Since a method of determining a work, and a method of computing a first degree of abnormality have been described above, description thereof is omitted herein.

In S12, the processing apparatus 10 determines whether the work has been switched (S12). The processing apparatus 10 repeatedly performs the pieces of processing of S10 and S11, and accumulates a processing result (a determination content of a work, and a first degree of abnormality) in S11. Then, when a work determined by the processing of S11 at this time, and a work determined by the processing of S11 at an immediately preceding time are different from each other, the processing apparatus 10 can determine that the work has been switched. Note that, an example of a condition in which it is determined that the work has been switched is not limited thereto.

When it is determined that the work has not been switched (No in S12), the processing apparatus 10 returns to S10, and repeats the processing.

On the other hand, when it is determined that the work has been switched (Yes in S12), the processing apparatus 10 computes a second degree of abnormality of the work that has been performed before the switching is performed (S13). As described above, the processing apparatus 10 repeatedly performs the pieces of processing S10 and S11, and accumulates a processing result (a determination content of a work, and a first degree of abnormality) in S11. For example, when it is determined in S12 that a work has been switched from “a first work” to “a second work”, the processing apparatus 10 computes a second degree of abnormality of the first work, based on a first degree of abnormality of the first work that has been accumulated so far. Since a method of computing a second degree of abnormality has been described above, description thereof is omitted herein.

Thereafter, the processing apparatus 10 determines whether the second degree of abnormality computed in S13 exceeds a warning value (S14). When the second degree of abnormality exceeds the warning value (Yes in S14), the processing apparatus 10 performs warning processing (S15). Thereafter, in a case where an instruction to finish the processing is not issued (No in S16), the processing apparatus 10 returns to S10, and repeats processing similar to the above. Since details on the warning processing have been described above, description thereof is omitted herein.

Further, when the second degree of abnormality does not exceed the warning value (No in S14), and in a case where an instruction to finish the processing is not issued (No in S16), the processing apparatus 10 returns to S10, and repeats processing similar to the above.

### “Advantageous Effect”

In the processing apparatus 10 according to the present example embodiment, an advantageous effect similar to that of the first example embodiment is achieved.

Further, in the processing apparatus 10 according to the present example embodiment, warning processing can be performed based on a comparison result between a second degree of abnormality and a warning value. Specifically, warning processing can be performed not based on a degree of abnormality at each timing (each image photographing time) when each work is being performed (first degree of abnormality), but based on a degree of abnormality of the first work computed by integrating the result (second degree of abnormality). Consequently, it is possible to avoid an inconvenience that a first degree of abnormality becomes a large value momentarily due to an unexpected factor not being related to a work content, and warning processing is erroneously performed based on the result.

Further, in the processing apparatus 10 according to the present example embodiment, by setting a plurality of warning values to be compared with a second degree of abnormality, a method of warning processing can be varied according to a warning value exceeding the second degree of abnormality. Consequently, it becomes possible to perform warning processing by an appropriate method according to a level of abnormality.

### Third Example Embodiment

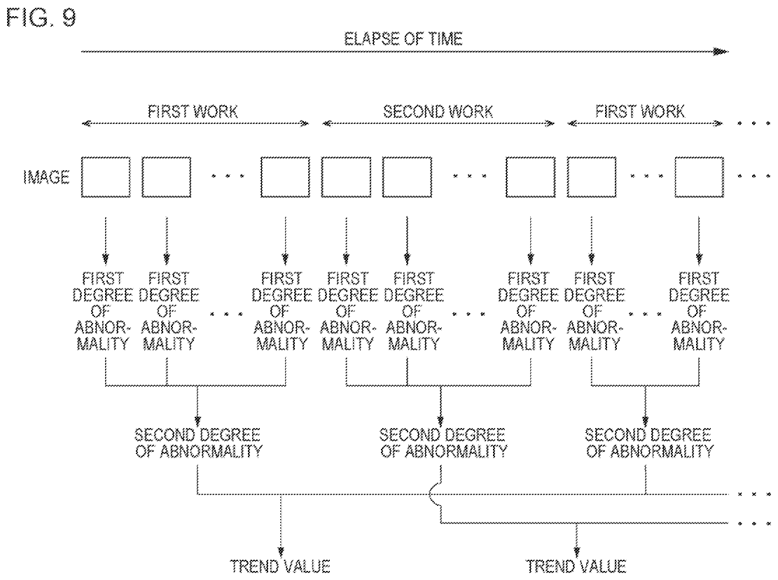

As illustrated in FIG. 9, a processing apparatus 10 according to a present example embodiment includes a function of computing the second degree of abnormality for each work, then statistically processing a second degree of abnormality of a same work, and computing a trend value for each work. In FIG. 9, a trend value of a first work is computed based on a second degree of abnormality of the first work being performed a plurality of times at each time. Further, a trend value of a second work is computed based on a second degree of abnormality of the second work being performed a plurality of times at each time. Hereinafter, details are described.

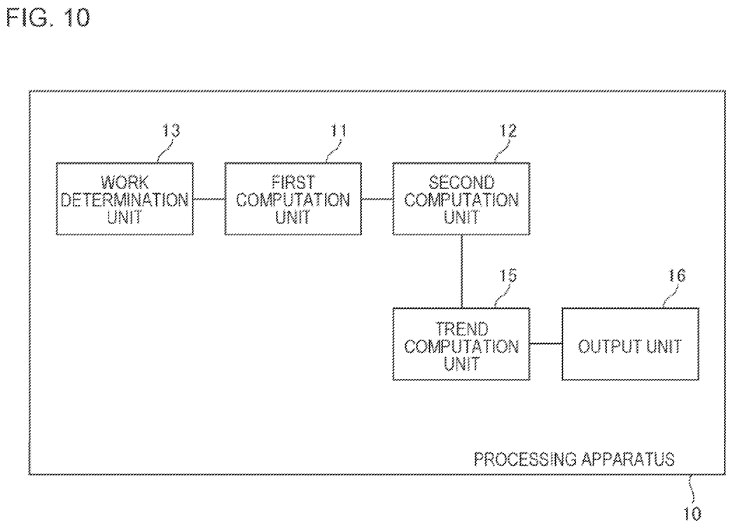

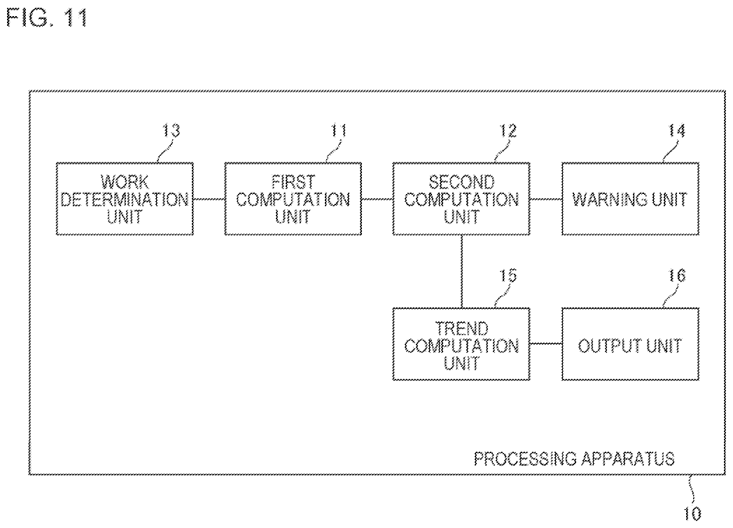

FIG. 10 illustrates one example of a functional block diagram of the processing apparatus 10 according to the present example embodiment. As illustrated in FIG. 10, the processing apparatus 10 includes a first computation unit 11, a second computation unit 12, a work determination unit 13, a trend computation unit 15, and an output unit 16. Note that, as illustrated in FIG. 11, the processing apparatus 10 according to the present example embodiment may further include a warning unit 14.

The trend computation unit 15 computes a trend value of a degree of abnormality of each work (such as a first work), based on a second degree of abnormality of each work (such as the first work) being performed a plurality of times at each time. The trend computation unit 15 computes a trend value by statistically processing a plurality of the second degrees of abnormality.

For example, the trend computation unit 15 may compute, as a trend value, a value acquired by adding up second degrees of abnormality. Further, the trend computation unit 15 may compute, as a trend value, an average value, a maximum value, a mode, a minimum value, or the like.

Further, the trend computation unit 15 may compute a trend value of each work for each predetermined attribute. The attribute includes a worker who performed a work, a weather (such as sunny, rainy, or cloudy) when a worker performed a work, a temperature, a time zone, a working place, a month, a day of the week, and the like. For example, the trend computation unit 15 may compute a trend value of each work for each worker, or compute a trend value of each work for each another attribute. Further, the trend computation unit 15 may compute a trend value of each work, when each condition is satisfied, for each condition (e.g., the weather is fine, and during a period from 9 a.m. until noon) in which the above-described plurality of attributes are combined.

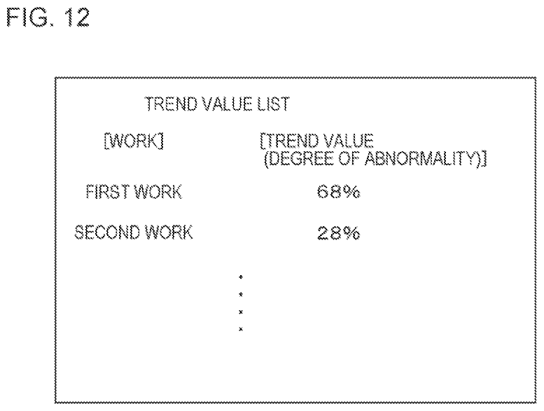

The output unit 16 outputs a trend value of each work. For example, as illustrated in FIG. 12, the output unit 16 may output a trend value of each of a plurality of works to be arranged. Further, the output unit 16 may output a trend value of each of a plurality of works to be arranged in a descending order or in an ascending order. Further, the output unit 16 may output a trend value of each of a plurality of works to be arranged for each predetermined attribute.

Further, when a trend value exceeds a reference value, the output unit 16 may output warning information. For example, the output unit 16 may display in an emphasizing manner a trend value exceeding a reference value in a list display of a trend value of each of a plurality of works as illustrated in FIG. 12.

The output unit 16 may display, on a display included in the processing apparatus 10, information as described above, may transmit information as described above to an external apparatus, or may store information as described above in a storage apparatus.

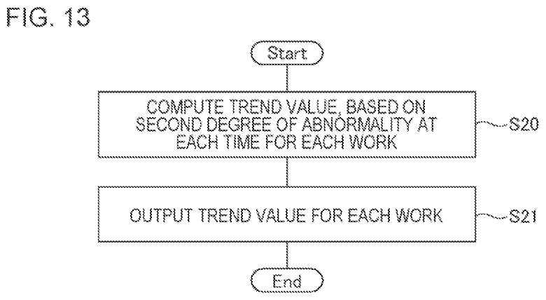

Next, one example of a flow of processing of the processing apparatus 10 is described by using a flowchart in FIG. 13.

The processing apparatus 10 computes a trend value, based on a second degree of abnormality at each time for each work (S20). Then, the processing apparatus 10 outputs the computed trend value for each work (S21).

Other configurations of the processing apparatus 10 according to the present example embodiment are similar to those of the first and second example embodiments.

In the processing apparatus 10 according to the present example embodiment, an advantageous effect similar to that of the first and second example embodiments is achieved. Further, in the processing apparatus 10 according to the present example embodiment, a trend value indicating a trend of a second degree of abnormality of each work being performed a plurality of times at each time can be computed.

The user can recognize, based on this trend value, a trend of a work being performed a plurality of times, for example, “a trend that a second degree of abnormality is high overall”, “a trend that a second degree of abnormality is low overall”, and the like. Further, the user can recognize, for example, a trend for each work as described below by combining a result of warning processing by the warning unit 14.
“A trend that warning processing has been performed because a second degree of abnormality exceeds a warning value, but the second degree of abnormality is low overall”
“A trend that warning processing has been performed because a second degree of abnormality exceeds a warning value, and the second degree of abnormality is high overall”
“A trend that a second degree of abnormality has never exceeded a warning value, and warning processing has never been performed, but the second degree of abnormality is high overall”
“A trend that a second degree of abnormality has never exceeded a warning value, and warning processing has never been performed, and the second degree of abnormality is low overall”

Further, as illustrated in FIG. 12, outputting a trend value of each of a plurality of works to be arranged allows the user to easily recognize a relationship on a trend value of a plurality of works. Further, outputting warning information when a trend value exceeds a reference value allows the user to easily recognize that a trend value of a certain work exceeds a reference value.

### Modification Example

In the above-described example embodiments, it is assumed that a worker repeatedly performs a plurality of works in a predetermined order. For example, a worker repeatedly performs a first work and a second work in this order. As a modification example, a worker may repeatedly perform a same work. For example, a worker may repeatedly perform a first work. In this case, the work determination unit 13 determines a break (a timing at which a certain work is finished, and a next work is started) of a work being performed a plurality of times, based on a state of a photographing target (such as a worker, a hand of a worker, a work object (such as a product and a material), a tool, and a workbench). Then, the processing apparatus 10 computes a second degree of abnormality for each work at each time by the method described in the above-described example embodiments. Further, the processing apparatus 10 computes a trend value, based on the second degree of abnormality at each time.

As described above, while the example embodiments according to the present invention have been described with reference to the drawings, these are an example of the present invention, and various configurations other than the above can also be adopted. Configurations of the above-described example embodiments may be combined with each other, or some of the configurations may be replaced by another configuration. Further, various modifications may be added to a configuration of the above-described example embodiments within a range that does not depart from the gist. Furthermore, a configuration and processing disclosed in the above-described example embodiments and modification examples may be combined with each other.

Further, in a plurality of flowcharts used in the above description, a plurality of processes (pieces of processing) are described in order. However, an order of execution of processes to be performed in each example embodiment is not limited to the order of description. In each example embodiment, the illustrated order of processes can be changed within a range that does not adversely affect a content. Further, the above-described example embodiments can be combined, as far as contents do not conflict with each other.

A part or all of the above-described example embodiments may also be described as the following supplementary notes, but is not limited to the following.
1. A processing apparatus including:
   a first computation unit that computes a first degree of abnormality being a degree of abnormality of a work at each image photographing time, based on a processing result of each of a plurality of images acquired by photographing a state of a first work being performed for a predetermined time; and
   a second computation unit that computes a second degree of abnormality being a degree of abnormality of the first work, based on a plurality of the first degrees of abnormality computed in association with each of the plurality of images.
2. The processing apparatus according to supplementary note 1, wherein the second computation unit computes the second degree of abnormality by statistically processing a plurality of the first degrees of abnormality.
3. The processing apparatus according to supplementary note 1 or 2, further including a warning unit that performs warning processing, when the second degree of abnormality exceeds a warning value.
4. The processing apparatus according to supplementary note 3, wherein
   a plurality of the warning values are defined, and
   the warning unit determines which one of a plurality of the warning values the second degree of abnormality has exceeded, and performs the warning processing by a method associated with a determined result.
5. The processing apparatus according to supplementary note 3 or 4, further including
   a work determination unit that analyzes the image, and determines a work being performed when the image is photographed, wherein
   the warning unit performs the warning processing in response to completion of the first work.
6. The processing apparatus according to any of supplementary notes 1 to 5, further including a trend computation unit that computes a trend value of a degree of abnormality of the first work, based on the second degree of abnormality of the first work being performed a plurality of times at each time.
7. The processing apparatus according to supplementary note 6, wherein the trend computation unit computes the trend value by statistically processing a plurality of the second degrees of abnormality.
8. The processing apparatus according to supplementary note 6 or 7, further including an output unit that outputs the trend value of each of a plurality of works to be arranged.
9. The processing apparatus according to any of supplementary notes 6 to 8, further including an output unit that outputs warning information when the trend value exceeds a reference value.
10. A processing method including,
   by one or more computers:
   computing a first degree of abnormality being a degree of abnormality of a work at each image photographing time, based on a processing result of each of a plurality of images acquired by photographing a state of a first work being performed for a predetermined time; and
   computing a second degree of abnormality being a degree of abnormality of the first work, based on a plurality of the first degrees of abnormality computed in association with each of the plurality of images.
11. A program causing a computer to function as:
   a first computation unit that computes a first degree of abnormality being a degree of abnormality of a work at each image photographing time, based on a processing result of each of a plurality of images acquired by photographing a state of a first work being performed for a predetermined time; and
   a second computation unit that computes a second degree of abnormality being a degree of abnormality of the first work, based on a plurality of the first degrees of abnormality computed in association with each of the plurality of images.
10 Processing apparatus
11 First computation unit
12 Second computation unit
13 Work determination unit
14 Warning unit
15 Trend computation unit
16 Output unit
1A Processor
2A Memory
3A Input/output I/F
4A Peripheral circuit
5A Bus

1. A processing apparatus comprising:
at least one memory configured to store one or more instructions; and
at least one processor configured to execute the one or more instructions to:
compute a first degree of abnormality being a degree of abnormality of a work at each image photographing time, based on a processing result of each of a plurality of images acquired by photographing a state of a first work being performed for a predetermined time; and
compute a second degree of abnormality being a degree of abnormality of the first work, based on a plurality of the first degrees of abnormality computed in association with each of the plurality of images.

2. The processing apparatus according to claim 1, wherein the processor is further configured to execute the one or more instructions to compute the second degree of abnormality by statistically processing a plurality of the first degrees of abnormality.

3. The processing apparatus according to claim 1, wherein the processor is further configured to execute the one or more instructions to perform warning processing, when the second degree of abnormality exceeds a warning value.

4. The processing apparatus according to claim 3, wherein
a plurality of the warning values are defined, and
the processor is further configured to execute the one or more instructions to determine which one of a plurality of the warning values the second degree of abnormality has exceeded, and perform the warning processing by a method associated with a determined result.

5. The processing apparatus according to claim 3, wherein the processor is further configured to execute the one or more instructions to
analyze the image, and determine a work being performed when the image is photographed, and
perform the warning processing in response to completion of the first work.

6. The processing apparatus according to claim 1, wherein the processor is further configured to execute the one or more instructions to compute a trend value of a degree of abnormality of the first work, based on the second degree of abnormality of the first work being performed a plurality of times at each time.

7. The processing apparatus according to claim 6, wherein the processor is further configured to execute the one or more instructions to compute the trend value by statistically processing a plurality of the second degrees of abnormality.

8. The processing apparatus according to claim 6, wherein the processor is further configured to execute the one or more instructions to output the trend value of each of a plurality of works to be arranged.

9. The processing apparatus according to claim 6, wherein the processor is further configured to execute the one or more instructions to output warning information when the trend value exceeds a reference value.

10. A processing method comprising,
by one or more computers:
computing a first degree of abnormality being a degree of abnormality of a work at each image photographing time, based on a processing result of each of a plurality of images acquired by photographing a state of a first work being performed for a predetermined time; and
computing a second degree of abnormality being a degree of abnormality of the first work, based on a plurality of the first degrees of abnormality computed in association with each of the plurality of images.

11. The processing method according to claim 10, wherein the one or more computers computes the second degree of abnormality by statistically processing a plurality of the first degrees of abnormality.

12. The processing method according to claim 10, wherein the one or more computers executes the one or more instructions to perform warning processing, when the second degree of abnormality exceeds a warning value.

13. The processing method according to claim 12, wherein
a plurality of the warning values are defined, and
the one or more computers determines which one of a plurality of the warning values the second degree of abnormality has exceeded, and performs the warning processing by a method associated with a determined result.

14. The processing method according to claim 12, wherein the one or more computers
analyzes the image, and determines a work being performed when the image is photographed, and
performs the warning processing in response to completion of the first work.

15. The processing method according to claim 10, wherein the one or more computers computes a trend value of a degree of abnormality of the first work, based on the second degree of abnormality of the first work being performed a plurality of times at each time.

16. A non-transitory storage medium storing a program causing a computer to:
compute a first degree of abnormality being a degree of abnormality of a work at each image photographing time, based on a processing result of each of a plurality of images acquired by photographing a state of a first work being performed for a predetermined time; and
compute a second degree of abnormality being a degree of abnormality of the first work, based on a plurality of the first degrees of abnormality computed in association with each of the plurality of images.

17. The non-transitory storage medium according to claim 16, wherein the program causing the computer to execute the one or more instructions to compute the second degree of abnormality by statistically processing a plurality of the first degrees of abnormality.

18. The non-transitory storage medium according to claim 16, wherein the program causing the computer to perform warning processing, when the second degree of abnormality exceeds a warning value.

19. The non-transitory storage medium according to claim 18, wherein
a plurality of the warning values are defined, and
the program causing the computer to determine which one of a plurality of the warning values the second degree of abnormality has exceeded, and perform the warning processing by a method associated with a determined result.

20. The non-transitory storage medium according to claim 18, wherein the program causing the computer to
analyze the image, and determine a work being performed when the image is photographed, and
perform the warning processing in response to completion of the first work.
